(19) United States
(12) Patent Application Publication
(10) Pub. No.: US 2003/0021880 A1
(43) Pub. Date: Jan. 30, 2003

(54) Methods of increasing hardness of food products

(76) Inventors: Russ Egbert, Decatur, IL (US); Victor Lobo, Decatur, IL (US); Zhongli Pan, Davis, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 10/050,047

(22) Filed: Jan. 17, 2002

Related U.S. Application Data
(60) Provisional application No. 60/262,031, filed on Jan. 18, 2001.

(51) Int. Cl. A23L 1/36

(52) U.S. Cl. 426/629

(57) ABSTRACT

Acidic phosphates are blended, agglomerated or spray-dried with soy protein products to provide a composition which improves the hardness of food systems. The usage of this composition in processed meat systems results in improved hardness and slicing properties of the finished meat product. The amount of acidic phosphates in the mixtures should be in the range of 0.01% to 10% by weight relative to total weight of the food product.

### CROSS REFERENCE TO RELATED APPLICATIONS

This application is a non-provisional of and claims priority to U.S. application Ser. No. 60/262,031, filed Jan. 18, 2001, the contents of which are incorporated herein by reference.

### BACKGROUND OF THE INVENTION

1. Field of the Invention

This invention relates to a method for improving the functional characteristics of food products. In particular, the invention relates to improving the hardness of food products comprising soy protein products.

2. Related Art

It has been reported that the phosphates interact with vegetable and animal proteins, carbohydrates, and gums to bind water and fat and form gel or sols of their solutions. The phosphates also have the ability to promote dispersion of food ingredients, such as protein, in brine solution for injected meat products and in dairy processing applications. They are also used in meat analogs and imitation dairy products, such as cheese and yogurt, to promote texture and simulate the integrity of the natural products.

### SUMMARY OF THE INVENTION

This invention is directed to a method of altering one or more textural properties of a food product comprising a) adding a composition comprising one or more soy protein products and one or more acidic phosphates to said food product, and b) determining one or more textural properties of said food product after addition of said composition to said food product; wherein one or more textural properties of said food product is altered when compared to said textural properties of said food product prior to addition of said composition.

The invention also relates to a food product comprising one or more acidic phosphates and one or more soy protein products selected from the group consisting of isolated soy protein, soy protein concentrate and soy flour, wherein one of said acidic phosphates is sodium acid pyrophosphate, and wherein the final concentration of said one or more acidic phosphates is from 0.01% to 10% of the mixture.

The invention provides a composition comprising about 2% to 6% sodium acid pyrophosphate, about 0.5% to 2.5% carrageenan, and about 92% to 97% soy protein concentrate. The invention also provides a method of using the composition comprising adding the composition to a food product wherein the final concentration of sodium acid pyrophosphate in the food product is from about 0.05% to 0.15%.

Further objects and advantages of the present invention will be clear from the description that follows.

### BRIEF DESCRIPTION OF THE FIGURES

FIG. 1. A graph depicting the relationship between peak height and peak width. Peak height×peak width=gel strength. Curve A: 130×1.0=130; Curve B: 400×2.0=800.

FIG. 2. A graph depicting Texture Profile Analysis (TPA) parameters of hardness, fracturability, cohesiveness, springiness, chewiness, gumminess and resilience. The graph is from the Texture Technology web site (texturetechnologies.com)

### DETAILED DESCRIPTION OF THE PREFERRED EMBODIMENTS

Definitions

In order to provide a clear and consistent understanding of the specification and claims, including the scope to be given such terms, the following definitions are provided. Some of the following definitions are provided by websites directed to food technology. See, the Food Product Design website (foodproductdesign.com) and the Texture Technology website (texturetechnologies.com).

Acidic phosphate(s). As used herein, the term refers to those phosphates, which, when put into solution, produce a solution with a pH below 7.0.

Adhesiveness. As used herein, adhesiveness is the force required to remove the material that adheres to a specific surface, i.e., lips, palate, teeth.

Bounce. As used herein, bounce is the resilience rate at which the sample returns to the original shape after partial compression.

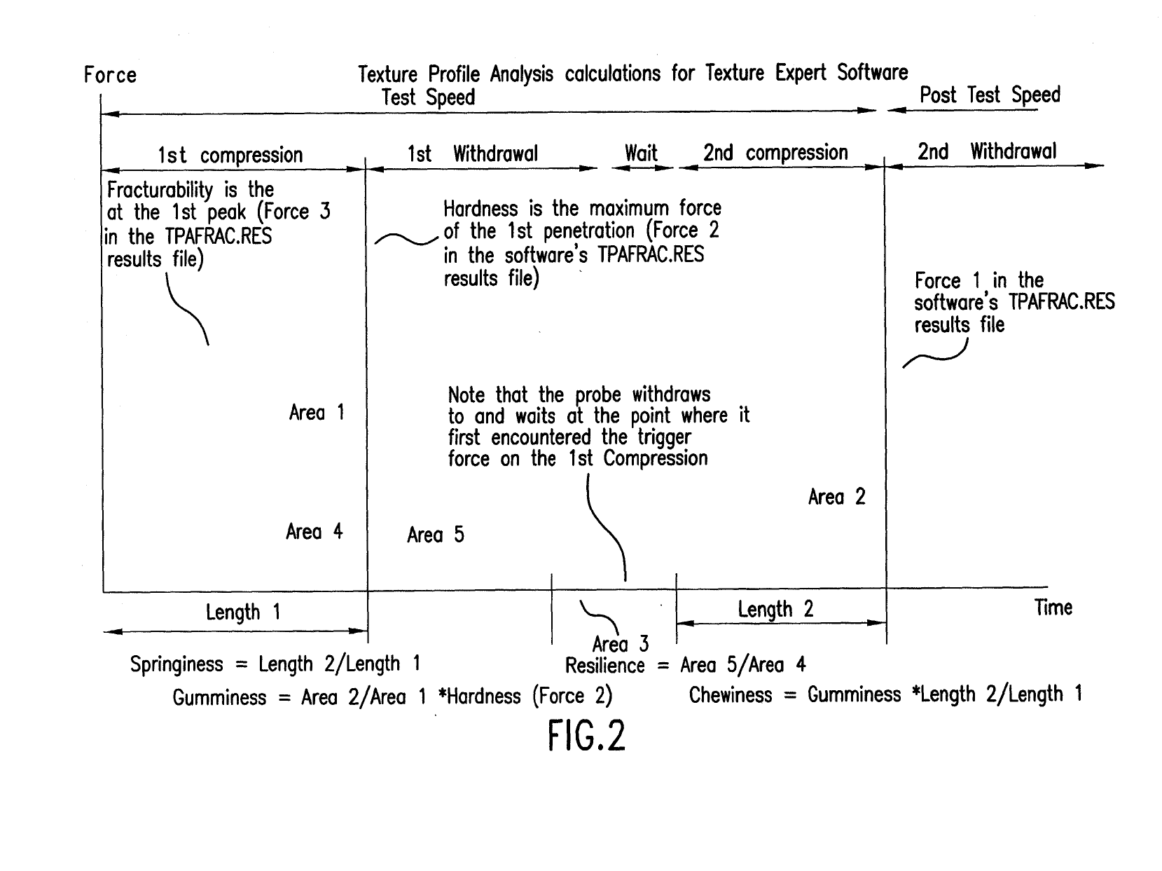

Chewiness. As used herein, chewiness only applies for solid products and is calculated as Gurnminess*Springiness (springiness is Length 2/Length 1; see FIG. 2). Chewiness is the number of chews (at one chew/second) needed to masticate the sample to a consistency suitable for swallowing.

Cohesiveness. As used herein, cohesiveness is how well the product withstands a second deformation relative to how it behaved under the first deformation. Cohesiveness is measured as the area of work during the second compression divided by the area of work during the first compression. (See, Area 2/Area 1 in FIG. 2). Cohesiveness is also the degree to which the sample deforms before rupturing when biting with molars.

Courseness. As used herein, courseness is the degree to which the mass feels coarse during product mastication.

Denseness. As used herein, denseness is the compactness of cross section of the sample after biting completely through with the molars.

Dryness. As used herein, dryness is the degree to which the sample feels dry in the mouth.

Food Product. As used herein, the term “food product” refers to any edible product. Food products include, but are not limited to, vegetable protein products, such as soy, for example, meat products and fruit products.

Fracturability. As used herein, fracturability is the force with which the sample crumbles, cracks or shatters. Fracturability encompasses crumbliness, crispness, crunchiness and brittleness. The fracturability point occurs where the plot has its first significant peak (where the force falls off) during the probe's first compression of the product. Not all products fracture.

Graininess. As used herein, graininess is the degree to which a sample contains small grainy particles.

Gumminess. As used herein, gumminess only applies to semi-solid products and is Hardness*Cohesiveness (cohesiveness is Area 2/Area; see FIG. 2). Gumminess is the energy required to disintegrate a semi-solid food to a state ready for swallowing.

Hardness. As used herein, the hardness value is the peak force of the first compression of the product. The hardness need not occur at the point of deepest compression, although it typically does for most products. Hardness is the force required to deform the product to a given distance, i.e., force to compress between molars, bite through with incisors, or compress between tongue and palate.

Heaviness. As used herein, heaviness is the weight of the product perceived when first place on the tongue.

Isolated soy proteins. As used herein, the term “isolated soy protein” refers to a soy protein powder wherein the powder is at least 90% soy proteins on a dry weight basis.

Moisture absorption. As used herein, moisture absorption is the amount of saliva absorbed by the product.

Moisture release. As used herein, moisture release is the amount of wetness/juiciness released from the sample.

Mouthcoating. As used herein, mouthcoating is the type and degree of coating in the mouth after mastication, for example, fat/oil.

Mouthfeel Analysis. As used herein, mouthfeel analysis involves a food's entire physical and chemical interaction in the mouth-from initial perception on the palate, to first bite, through mastication and the act of swallowing. Mouthfeel analysis is involved in the sensory evaluation of textural properties. Properties involved in mouthfeel analysis include, but are not limited to: adhesiveness, bounce, coarseness, denseness, dryness, graininess, heaviness, moisture absorption, moisture release, mouthcoating, roughness, slipperiness, smoothness, uniformity, uniformity of chew, uniformity of bite, viscosity and wetness.

Resilience. As used herein, resilience is how well a product “fights to regain its original position.” Resilience can be thought of as instant springiness, since resilience is measured on the withdrawal of the first penetration, before the waiting period is started.

The calculation is the area during the withdrawal of the first compression, divided by the area of the first compression (Area 5/Area4 in FIG. 2).

Resilience is not always measured with texture profile analysis (TPA) calculations, and was not a direct part of the original TPA work. Resilience can be measured with a single compression; however, the withdrawal speed must be the same as the compression speed.

Roughness. As used herein, roughness is the degree of abrasiveness of a product's surface as perceived by the tongue.

Slipperiness. As used herein, slipperiness is the degree to which the product slides over the tongue.

Smoothness. As used herein, smoothness is the absence of any particles, lumps, bumps, etc., in the product.

Soy protein concentrate. As used herein, the term refers to a soy protein powder wherein the powder is at least 65% soy proteins on a dry weight basis.

Soy Protein Product. As used herein, the term “soy protein product” refers to any one or more of soy protein concentrate, isolated soy proteins, and soy flour.

Soy Protein Product Mixture. As used herein, the term “soy protein product mixture” refers to a mixture comprising one or more of soy protein concentrate, isolated soy proteins, soy flour, sodium acid pyrophosphate, and other ingredients, such as carrageenan and/or corn starch, for example.

Springiness. As used herein, springiness is how well a product physically springs back after it has been deformed during the first compression. The springback is measured at the downstroke of the second compression, so the wait time between two strokes can be relatively important. In some cases an excessively long wait time will allow a product to springback more than it might under the conditions being researched.

Springiness is measured several ways, but most typically, by the distance of the detected height of the product on the second compression (Length 2 in FIG. 2), as divided by the original compression distance (Length 1). The original definition of springiness used the Length 2 only, and the units were in mm or other units of distance. However, the original description of springiness is not as useful since the springiness value can only be compared among products which are identical in their original shape and height. Many texture profile analysis users compress their products (% strain), and for those applications a pure distance value (rather than a ratio) is too heavily influenced by the height of the sample. By expressing springiness as a ratio of its original height, comparisons can be made between a broader set of samples and products.

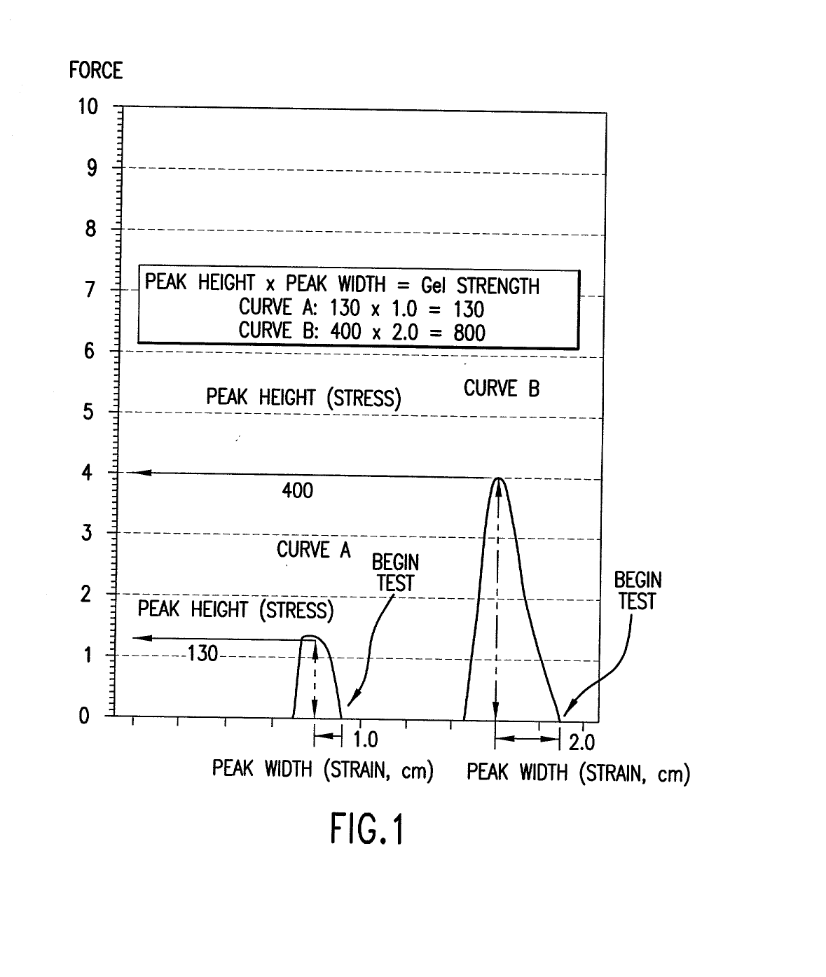

Strain. As used herein, the term refers to the degree of elasticity. The lower the number the more brittle the product. The peak width is an indication of the strain. See, FIG. 1. Given similar peak height, the lower the number the more brittle the product.

Stress. As used herein, the term refers to firmness or hardness. The shorter the height, the less firm the gel. The peak height is an indication of the stress. See, FIG. 1.

Textural Profile Analysis. As used herein, the phrase is understood to include, but is not limited to, measurements of textural properties such as, for example, stress, strain, hardness, fracturability, cohesiveness, springiness, chewiness, gumminess, and resilience. Textural properties may be evaluated using instrumental or sensory evaluation, including animal or human testers.

Uniformity. As used herein, uniformity is the degree to which the sample is even throughout.

Uniformity of Chew. As used herein, uniformity of chew is the degree to which the chewing characteristics of the product are even throughout mastication.

Uniformity of Bite. As used herein, uniformity of bite is evenness of force through bite.

Viscosity. As used herein, viscosity is the force required to draw a liquid from a spoon over the tongue.

Wetness. As used herein, wetness is the amount of moisture perceived on the product's surface.

Soy proteins have been considered as the most valuable, economical, and plentiful protein source for meeting the food needs of the growing population in the world. In recent years, recognition of health and nutritional benefits of soy protein has considerably increased the consumption of soy protein products containing various levels of soy protein as human foods. Soy protein products have been used widely as meat extenders or substitutes and as an ingredient in various foods, such as vegetarian foods, baked goods and beverages. However, one of the obstacles limiting the further usage of some soy protein products in complex food systems is the functional properties of hardness and texture of these soy proteins.

It has been discovered that acidic phosphates are very effective ingredients for improving the hardness and slicing properties of gels made from soy protein products as well as other food products. Acidic phosphates include, but are not limited to, sodium acid pyrophosphate, potassium metaphosphate, sodium aluminum phosphate, monoammonium phosphate, monocalcium phosphate, ferric orthophosphate, monopotassium phosphate, hemisodium phosphate, and monosodium phosphate. The U.S. Food and Drug Administration (FDA) considers these ingredients as GRAS (Generally Recognized As Safe). Any acidic phosphate generally recognized as safe is contemplated for use in the invention. Other such GRAS phosphates contemplated include, but are not limited to, phosphoric acid, sodium tripolyphosphate, sodium acid phosphate, calcium hexametaphosphate, monobasic calcium phosphate, dipotassium phosphate, disodium phosphate, sodium hexametaphosphate, sodium metaphosphate, sodium phosphate, sodium pyrophosphate, tetrasodium pyrophosphate, calcium pyrophosphate, calcium phosphate, sodium phosphate, monobasic ammonium phosphate, dibasic ammonium phosphate, ferric phosphate, ferric pyrophosphate, and magnesium phosphate.

Soybeans can be processed to produce various soy protein products including soy flours and grits, soy protein concentrates, and isolated soy protein with protein contents of 50%, 65%, and 90% on a dry weight basis, respectively. Soy protein products have been used as meat substitutes in processed meat products to reduce cost and/or improve textural properties, health benefits, nutritional values, and the quality of meat products. Soy protein products are also unique ingredients for vegetarian foods, such as meat analogs, soy beverages and nutrition bars due to their functional characteristics and health benefits.

The functional properties of soy products include gel hardness, water holding capacity, solubility, dispersability, and viscosity, etc. Gel hardness (firmness) is one of the most important functional characteristics for meat, vegetarian and certain dairy food systems. Gel hardness can be determined for soy protein products by measuring the hardness of the soy protein gel with an instrument that measures the textural properties of food. Gel hardness is typically related to the hardness of the finished food products and is affected by the protein content of the soy protein products as well as the processing conditions used to manufacture soy protein products. Soy protein products with higher protein levels typically provide increased hardness in finished food products. The color that soy products impart is also very important for certain food applications, such as dairy products, which may require a lighter color than is achieved with typical soy proteins.

The physical measurements obtained by instrumental analysis can be correlated with sensory data (mouthfeel analysis). See, the websites for Texture Technologies Corp. (texturetechnologies.com) and Food Product Design (foodproductdesign.com). Sensory data is obtained by using a well trained sensory panel. The sensory panel is selected using a statistically random sample of people from throughout the United States. To carry out a meaningful texture profile analysis, the panel of judges needs to have prior knowledge of the classification system, the use of standard rating scales and the correct procedures relating to the mechanics of testing. Panelists should have a clear definition of each attribute (i.e., adhesiveness). The techniques used to evaluate the food product of interest should be explicitly specified, explaining how the food product is placed in the mouth, whether it is acted upon by the teeth (and which teeth) or by the tongue and what particular sensation is to be evaluated. Panelists should be given reference standards for evaluation so they can practice their sensory evaluation techniques and the use of scales. Once the panel has been trained, the attributes that are relevant and important to the food product should be determined. A range of products is then selected that covers the extremes and middle ground of all the most critical attributes of the food product of interest. The next step is to perform an organoleptic sensory evaluation in which the trained panelists assign intensity levels of the chosen attributes. For example, for evaluating the texture of pickles, firmness may be considered one important attribute. In this instance, panelists could be asked: “On a scale where 1 equals extremely soft and 9 equals extremely firm, how would you rate the firmness of pickles A, B and C?” Once taste paneling is complete, instrument readings of the food product are made. The instrumental technique selected should duplicate as closely as possible how the mouth manipulates the particular food product, i.e., the instrument should apply the same amount of force in the same direction and at the same rate as the mouth and teeth during mastication. Then, a statistical correlation is obtained between the sensory data and the instrumental measurements. Often, excellent correlations between the taste panel results and instrument results can be obtained. Sometimes, however, a good correlation of any type between the instrument readings and taste panel scores can not be obtained.

Soy protein isolates normally have superior functional properties to other soy protein products especially in the area of gelling properties, but soy protein isolates are the most expensive. To reduce the costs of finished food products and modify the functional properties of soy protein products, other food ingredients including various starches, guns, and wheat flours, may be used in combination with soy protein products in manufactured food products. One of the common practices is to blend these ingredients with soy protein products. However, the addition of these ingredients may reduce the effectiveness of soy protein products in improving or maintaining the quality of finished food products. An effective method for achieving the desired functionality of such mixtures should be explored.

Soy flours and soy protein concentrates normally have weaker gel characteristics or hardness than isolated soy protein. These proteins may or may not possess the necessary gelling characteristics to meet the texture quality requirement of the finished food products. Several soy protein concentrates on the market have very good functionality (water holding and fat binding properties) but may not possess the required textural properties.

The weak gelling characteristics of mixtures of soy protein products and starch can result in unsatisfactory textural quality of finished food products, such as soft texture and/or poor slicing properties of hams. This suggests a need to improve the functional properties that these soy protein products impart to the finished food product, especially product hardness. New soy protein products having improved functional properties will provide improved functionality to the finished food product at relatively low cost to customers.

This invention is directed to a method of altering one or more textural properties of a food product comprising a) adding a composition comprising one or more soy protein products and one or more acidic phosphates to said food product, and b) determining one or more textural properties of said food product after addition of said composition to said food product; wherein one or more textural properties of said food product is altered when compared to said textural properties of said food product prior to addition of said composition. In one embodiment, said one or more textural properties is selected from the group consisting of hardness, fracturability, cohesiveness, springiness, chewiness, gumminess, and resilience. In another embodiment of the method, said altered textural property of said food product is an increase in hardness.

In one embodiment of the method, said acidic phosphates are one or more of sodium acid pyrophosphate, potassium metaphosphate, sodium aluminum phosphate, monoammonium phosphate, monocalcium phosphate, ferric orthophosphate, monopotassium phosphate, hemisodium phosphate and monosodium phosphate. In another embodiment of the method, said soy protein products are selected from soy flours, soy protein concentrates and isolated soy proteins. In a preferred embodiment of the method, said soy protein product is soy protein concentrate. In one embodiment of the method, said composition additionally comprises one or more of native and modified starches, wheat gluten and flours, xanthan gum, locust bean gum, carrageenan, pectin and guar gum. In another embodiment of the method, said composition additionally comprises one or more of gelatin, egg albumin and blood plasma. In another embodiment of the method, the composition comprises about 4% sodium acid pyrophosphate, about 1.5% carrageenan, and about 94.5% soy protein concentrate, wherein the final concentration of sodium acid pyrophosphate in the food product is from 0.01% to 0.15%. In another embodiment of the method, the final concentration of acidic phosphates is from 0.01% to 10%. The invention is also directed to a food product made by the method.

The invention also relates to a food product comprising one or more acidic phosphates and one or more soy protein products selected from the group consisting of isolated soy protein, soy protein concentrate and soy flour, wherein one of said acidic phosphates is sodium acid pyrophosphate, and wherein the final concentration of said one or more acidic phosphates is from 0.01% to 10% of the mixture. In one embodiment, the food product further comprises carrageenan. In one embodiment of the invention, said sodium acid pyrophosphate final concentration is from 0.01% to 0.5%. In another embodiment, said sodium acid pyrophosphate concentration is from 0.05% to 0.25%. In a preferred embodiment, the food product additionally comprises corn starch. In another embodiment, the food product additionally comprises water, meat, salt, potato starch, sucrose, sodium nitrite, sodium tripolyphosphate, and erythorbate.

The invention also provides a composition comprising about 2% to 6% sodium acid pyrophosphate, about 0.5% to 2.5% carrageenan, and about 92% to 97% soy protein concentrate. In one embodiment, the composition comprises about 4% sodium acid pyrophosphate, about 1.5% carrageenan, and about 94.5% soy protein concentrate. The invention also provides a method of using the composition comprising adding the composition to a food product wherein the final concentration of sodium acid pyrophosphate in the food product is from 0.05% to 0.15%.

In order to provide a control for comparison and analysis, each soy protein product was used as the control for comparison with the inventive soy protein products. The mixtures of soy protein products were made by inclusion of sodium acid pyrophosphate to combinations of isolated soy protein, soy protein concentrates, soy flours, and other food ingredients. Soy protein gels were made with one part of the soy protein or soy protein mixture and four parts of water and made as follows:

1. Weigh 400 g of water (˜45° F. or 7° C.) and place in food processor.

2. Weight out 100 g of protein sample to be tested and add to water in food processor.

3. Place lid on food processor and chop for 30 seconds. Scrape down sides and chop additional 2.5 minutes.

4. After chopping, transfer mix to a vacuum desiccator. For proteins with less than 15,000 cps viscosity, vacuum contents for 5 minutes. If sample is very viscous (greater than 15,000 cps), vacuum for 15 minutes. Vacuum at 20 inches of Hg (50 cm of Hg).

5. Spoon 125-130 g of vacuumed mix into each of 4 cans, identify and seal cans.

6. Centrifuge each can at 1,700 rmp (700×g) for 10 minutes.

7. Place 4 cans in 185° F. (85° C.) water bath for 60 minutes.

8. Remove cans from water-bath and refrigerate all 4 cans overnight at 40° F. (4° C.)].

9. The next morning remove cans from refrigerator and allow to equilibrate to room temperature for 2 hours.

10. Open cans and carefully remove gel from can.

11. Cut gel to 3 cm (measured from bottom of gel). Use the cut side of lower half to determine gel strength using a Rheometer with 8 mm diameter ball spindle.

The textural quality (TA-XT2 Texture Analyser, Texture Technologies Corp., Scarsdale, N.Y.) of the samples is evaluated visually and instrumentally. The TA-XT2 Texture Analyser, can determine adhesion, bloom strength, breaking point, cohesion, creep, crispiness, density, extrudability, film strength, hardness, lumpiness, rubberiness, slipperiness, smoothness, softness, spreadability, springback, tackiness and tensile strength. Hardness was determined by measuring the stress (peak force) and strain (elasticity) of the gels with Fudoh Rheo® Meter (Rheometer with 8 mm ball spindle and attached strip chart recorder—Model NRM-2002J, Tokyo, Japan).

In the gel test method, hardness was determined in the following manner:

Center spindle over center of gel and allow spindle to penetrate gel until peak is reached. Stop test, allowing chart pen to come back to base line. Measure from this line to the point at which the pen left the base line on the upward path of the peak (see FIG. 1). The peak height is multiplied by the peak width to obtain the gel strength value. Always run a control protein sample of known gel strength with each group of unknowns.

Samples with improved textural characteristics (hardness) were differentiated from other samples at similar gel strength by their higher stress values and lower strain values. To evaluate the slicing properties of the samples of soy protein gels and hams, the samples are sliced with a knife and mechanical slicing device. Slicing properties of the gels and/or hams were compared relative to products of similar composition (i.e. isolated soy protein-based or soy protein concentrate-based).

The color of protein gels was measured with a Hunter Lab® color meter HunterLab D25L Optical Sensor, HunterLab, Reston, Va.). The L values were determined with higher L values reflecting a lighter colored product.

Many of the soy protein products used in various examples described herein are commercially available from the Archer Daniels Midland Company (ADM) at Decatur, Ill. These soy protein products are designed to have various functionality characteristics and are suitable for many different food applications. Soy protein products may also affect mouthfeel analysis.

The following are various examples of the mixtures of soy protein products and acidic phosphates used to demonstrate the ability of acidic phosphates to improve the functional characteristic of soy protein products, such as product hardness and slicing properties. The effectiveness of carrageenan on further improving the functional properties of the mixtures was also demonstrated.

### EXAMPLE 1

Isolated soy proteins (ISP) normally provide superior textural properties to food systems, but are relatively expensive compared to other soy protein products. To reduce the cost for certain applications, one of the common practices is to use starch to reduce the amount of isolated soy protein used in a meat system and thus reducing overall formulation costs. If the isolated soy protein and starch are combined, the gelling properties of the mixture is typically weak. In this example, one of the acidic phosphates was included in the isolated soy protein and starch mixtures to improve textual integrity (hardness). The mixtures of ISP, corn starch (ADM, Decatur, Ill.), and sodium acid pyrophosphates (FMC Inc., Philadelphia, Pa.) were made at various ratios (Table 1). The content of sodium acid pyrophosphate in the mixture ranged from 2-4%. One control sample was used to compare the effectiveness of the sodium acid pyrophosphate in improving the textural properties of these soy protein products. The effect of sodium acid pyrophosphate on the pH of the gel was also determined by measuring the pH of the gel samples with a pH meter.

The addition of sodium acid pyrophosphate reduced the strain (elasticity), but increased the stress (peak force) as the level of sodium acid pyrophosphate was increased from 0-3%. The slicing properties of the soy protein gels were improved by the addition of sodium acid pyrophosphate. The gel texture after cooking was not uniform after the sodium acid pyrophosphate concentration reached levels of 4% of the mixture. As sodium acid pyrophosphate concentration increased, gel pH decreased and product color lightened. The addition of carrageenan (FMC Inc., Philadelphia, Pa.) to the mixture protein product demonstrated positive effects on the gel hardness and properties.

TABLE 1
Formulation and gel test results of soy product mixtures

| | | Texture | | | |
|---|---|---|---|---|---|
| Sample | | Strain | Stress | | Color |
| No. | Mixture Formulation | (cms) | (gms force) | pH | (L Value) |
| 1 | 65.00% ISP + 35.00% CS | 1.09 | 142 | 6.98 | 60.7 |
| 2 | 63.70% ISP + 34.30% CS + 2.00% SAPP | 0.90 | 164 | 6.49 | 62.3 |
| 3 | 63.05% ISP + 33.95% CS + 3.00% SAPP | 0.87 | 170 | 6.36 | 63.3 |
| 4 | 62.40% ISP + 33.60% CS + 4.00% SAPP | — | — | 6.23 | — |
| 5 | 62.725% ISP + 33.775% CS + 2.50% | 0.77 | 159 | | 63.8 |
| | SAPP + 1.00% CG | | | | |

ISP: Isolated soy protein-ProFam 974
CS: Corn starch
SAPP: Sodium acid pyrophosphate
CG: Carrageenan-ME8121

### EXAMPLE 2

Blends of soy protein concentrate (Arcon S), sodium acid pyrophosphates, and carrageenan were made at various ratios (Table 2). The content of sodium acid pyrophosphate in the mixtures ranged from 1-2%. A control sample, 100% Arcon S, was used to compare the effectiveness of sodium acid pyrophosphate in improving the functional properties of the soy protein products. One percent carrageenan was also used in some soy protein product mixtures to examine its effect on the functional properties of the soy protein mixtures.

The addition of sodium acid pyrophosphate significantly reduced the elasticity as indicated by the lower strain values and results in improved gel hardness (stress). The addition of carrageenan in the mixtures further improved the hardness of the gels. The samples with sodium acid pyrophosphate showed better slicing properties than the control. The best slicing properties were obtained from Sample No. 5 containing 2% sodium acid pyrophosphate and 1% carrageenan. The color of gels containing sodium acid pyrophosphate were significantly lighter than the control. Increased levels of sodium acid pyrophosphate in the soy protein concentrates resulted in a lighter color of gel.

TABLE 2
Formulation and gel test results of soy product mixtures

| | | Texture | | |
|---|---|---|---|---|
| | | | Stress | |
| Sample | | Strain | (gms | Color |
| No. | Mixture Formulation | (cms) | force) | (L Value) |
| 1 | 100.00% Arcon S | 0.76 | 170 | 64.3 |
| 2 | 99.00% Arcon S + 1.00% SAPP | 0.70 | 167 | 65.3 |
| 3 | 98.00% Arcon S + 2.00% SAPP | 0.69 | 153 | 66.1 |
| 4 | 98.00% Arcon S + 1.00% SAPP + | 0.65 | 189 | 65.4 |
| | 1.00% CG | | | |
| 5 | 97.00% Arcon S + 2.00% SAPP + | 0.61 | 157 | 66.3 |
| | 1.00% CG | | | |

Arcon S: Soy protein concentrate
SAPP: Sodium acid pyrophosphate
CG: Carrageenan-ME8121

### EXAMPLE 3

Blends of soy protein concentrates (Arcon S), isolated soy protein, sodium acid pyrophosphates, and carrageenan were made at various ratios (Table 3). Two levels of isolated soy protein, 10% and 20%, were used in the mixtures. The content of sodium acid pyrophosphate in the mixtures ranged from 0-2%. One percent carrageenan was used in two mixtures to examine its effects on the functional properties of the soy protein product mixtures.

Sodium acid pyrophosphate in the mixture reduced the elasticity (strain) while maintaining relatively high stress values. The addition of carrageenan in mixture further reduced the strain, but increased the stress. Therefore, the soy protein gels with sodium acid pyrophosphate and carrageenan had greater hardness. Gels from sample No. 6 had the firmest texture among the six samples. Addition of sodium acid pyrophosphate significantly improved the color (lighter) of the soy protein gels and addition of carrageenan into the mixtures showed slight improvements in gel color. Improved slicing properties were obtained for soy protein gels with sodium acid pyrophosphate with or without carrageenan compared to control.

TABLE 3
Formulation and gel test results of soy product mixtures

| | | Texture | | |
|---|---|---|---|---|
| | | | Stress | Color |
| Sample | | Strain | (gms | |
| No. | Mixture Formulation | (cms) | force) | (L Value) |
| 1 | 90.00% Arcon S + 10.00% ISP | 0.82 | 194 | 64.3 |
| 2 | 88.00% Arcon S + 10.00% ISP + | 0.70 | 166 | 66.3 |
| | 2.00% SAPP | | | |
| 3 | 87.00% Arcon S + 10.00% ISP + | 0.63 | 172 | 66.5 |
| | 2.00% SAPP + 1.00% CG | | | |
| 4 | 80.00% Arcon S + 20.00% ISP | 0.84 | 198 | 64.1 |
| 5 | 78.00% Arcon S + 20.00% ISP + | 0.70 | 174 | 66.2 |
| | 2.00% SAPP + 1.00% CG | | | |
| 6 | 77.00% Arcon S + 20.00% ISP + | 0.63 | 190 | 66.4 |
| | 2.00% SAPP + 1.00% CG | | | |

ISP: Isolated soy protein-ProFam 974;
Arcon S: Soy protein concentrate;
SAPP: Sodium acid pyrophosphate;
CG: Carrageenan-ME8121

### EXAMPLE 4

Blends of soy protein concentrate (Arcon SM), sodium acid pyrophosphates, and carrageenan were made at various ratios to demonstrate the effect of sodium acid pyrophosphate on the soy protein gel hardness (Table 4). The amount of sodium acid pyrophosphate in the mixtures ranged from 0-4%. One percent carrageenan was used in four mixtures to examine the interaction of its effect on the functional properties of the soy protein product mixtures.

Addition of sodium acid pyrophosphate to soy protein concentrate significantly reduced elasticity and peak force in soy protein gel made with Arcon the level of sodium acid pyrophosphate increased from 0-3%. These changes in stress and strain resulted in improved firmness and slicing properties of the soy protein gel mixtures. Further increases of sodium acid pyrophosphate to 4% in the mixture showed no further improvement in functional properties. The mixture containing 3% sodium acid pyrophosphate and 1% carrageenan had the firmest texture and best slicing properties. It was also observed that addition of sodium acid pyrophosphate lightened soy protein gel color.

TABLE 4
Formulation and gel test results of soy product mixtures

| | | Texture | |
|---|---|---|---|
| | | | Stress |
| Sample | | Strain | (gms |
| No. | Mixture Formulation | (cms) | force) |
| 1 | 100.00% Arcon SM | 0.91 | 221 |
| 2 | 99.00% Arcon SM + 1.00% SAPP | 0.85 | 193 |
| 3 | 98.00% Arcon SM + 2.00% SAPP | 0.70 | 175 |
| 4 | 97.00% Arcon SM + 3.00% SAPP | 0.67 | 166 |
| 5 | 96.00% Arcon SM + 4.00% SAPP | 0.69 | 148 |
| 6 | 98.00% Arcon SM + 1.00% SAPP + 1.00% CG | 0.79 | 220 |
| 7 | 97.00% Arcon SM + 2.00% SAPP + 1.00% CG | 0.70 | 197 |
| 8 | 96.00% Arcon SM + 3.00% SAPP + 1.00% CG | 0.65 | 185 |
| 9 | 95.00% Arcon SM + 4.00% SAPP + 1.00% CG | 0.69 | 142 |

Arcon SM: Soy protein concentrate
SAPP: Sodium acid pyrophosphate
CG: Carrageenan-ME8121

### EXAMPLE 5

Blends of soy flour (Bakers Nutrisoy Flour), soy protein concentrate (Arcon SM), sodium acid pyrophosphate, and carrageenan were made at various ratios (Table 5). The content of sodium acid pyrophosphate in the mixture ranged from 0-4%. One percent carrageenan was used in four mixtures to examine its effect on the functional properties of the soy protein product mixtures. The hardness of soy protein gels were evaluated by measuring the stress at 4 mm of strain. Higher stress values for the soy protein gel mixtures indicate greater hardness.

Addition of sodium acid pyrophosphate to the mixture of soy flours and soy protein concentrates significantly improved the hardness of the soy protein gels. It was observed that addition of sodium acid pyrophosphate and carrageenan improved slicing properties. The mixtures of soy flour and soy protein concentrate containing 4% sodium acid pyrophosphate and 1% carrageenan were the firmest in texture with the best slicing properties. Addition of sodium acid pyrophosphate and carrageenan significantly lightened the color of the soy protein gel mixtures.

TABLE 5
Formulation and gel test results of soy product mixtures

| | | Texture and Color | |
|---|---|---|---|
| | | Stress at | Color |
| Sample | | 4 mm of | (L |
| No. | Mixture Formulation | strain | Value) |
| 1 | 70.00% Arcon SM + 30.00% BNS | 41 | 68.2 |
| 2 | 69.30% Arcon SM + 29.70% BNS + | 41 | 69.6 |
| | 1.00% SAPP | | |
| 3 | 68.60% Arcon SM + 29.40% BNS + | 49 | 70.5 |
| | 2.00% SAPP | | |
| 4 | 67.90% Arcon SM + 29.10% BNS + | 49 | 71.5 |
| | 3.00% SAPP | | |
| 5 | 67.20% Arcon SM + 28.80% BNS + | 45 | 72.3 |
| | 4.00% SAPP | | |
| 6 | 68.60% Arcon SM + 29.40% BNS + | 67 | 70.0 |
| | 1.00% SAPP + 1.00% CG | | |
| 7 | 67.90% Arcon SM + 29.10% BNS + | 80 | 71.0 |
| | 2.00% SAPP + 1.00% CG | | |
| 8 | 67.20% Arcon SM + 28.80% BNS + | 90 | 72.4 |
| | 3.00% SAPP + 1.00% CG | | |
| 9 | 66.50% Arcon SM + 28.50% BNS + | 92 | 73.1 |
| | 4.00% SAPP + 1.00% CG | | |

Arcon SM: Soy protein concentrate
BNS: Bakers Nutrisoy Flour-soy flour
SAPP: Sodium acid pyrophosphate
CG: Carrageenan-ME8121

### EXAMPLE 6

Selected mixtures of soy protein products were used in tests of extended hams (Table 6). The ham formulation included: 44.4% turkey thigh meat, 2.5% soy protein product mixture, 43.3% water, 2.1% salt, 3.0% potato starch, 0.4% carrageenan, and 4.3% other ingredients (sucrose, sodium tripolyphosphate, erythorbate, and sodium nitrite).

The brine solution was first made by 1) adding soy protein mixture to chilled water, and mixing to hydration; 2) adding sodium tripolyphosphate, sodium nitrite, erythorbate and salt, and mixing for 30 seconds; 3) adding sucrose and carrageenan, and mixing for 30 seconds; and 4) adding potato starch and mixing for 30 seconds.

Hams were made using the following procedures:

1. Turkey thigh meat was ground through 6.35 mm (¼″) plate.

2. Meat and brine solutions were placed in mixer and mixed for 18 minutes under vacuum.

3. Meat mixture was stuffed into non-permeable casing with a stuffer.

4. Hams were cooked to an internal temperature of 72 to 75° C. in an 85° C. water bath.

The hams were held at 4° C. overnight before they were evaluated for hardness and slicing properties. The hams were cut into 20×20 mm cubes for hardness measurement. The samples were compressed 3 mm using TA-XT2 Texture Analyser (Scarsdale, N.Y.) and peak force measured. These peak force values were used as an indicator of ham hardness and are reported in Table 6.

TABLE 6
Formulation of soy product mixtures for ham application and ham texture

| | Mixture Formulation | | | | | Ham |
|---|---|---|---|---|---|---|
| Sample | Corn | | Concen- | | | Texture |
| No. | Starch | ISP^{a} | trate^{b} | SAPP^{c} | Carrageenan^{d} | Force (g) |
| 1 | | | 100 | | | 552 |
| 2 | | | 96 | 4 | | 585 |
| 3 | | | 94.5 | 4 | 1.5 | 589 |
| 4 | 33.6 | 62.4 | | 4 | | 490 |
| 5 | 33.1 | 61.4 | | 4 | 1.5 | 509 |

^{a}Isolated soy protein (ProFam 974)
^{b}Soy protein concentrate
^{c}Sodium acid pyrophosphate
^{d}ME8121

The results clearly demonstrate inclusion of sodium acid pyrophosphate with soy protein concentrate or isolated soy protein mixture significantly improved the hardness of hams. Adding carrageenan to this mixture of soy protein and sodium acid pyrophosphate resulted in a slight increase in product hardness. Slicing properties of the hams were improved by the addition of sodium acid pyrophosphate or sodium acid pyrophosphate and carrageenan to the soy protein mixtures.

Having now fully described the present invention in some detail by way of illustration and example for purposes of clarity of understanding, it will be obvious to one of ordinary skill in the art that same can be performed by modifying or changing the invention with a wide and equivalent range of conditions, formulations and other parameters thereof, and that such modifications or changes are intended to be encompassed within the scope of the appended claims.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1. A method of altering one or more textural properties of a food product comprising
(a) adding a composition comprising one or more soy protein products and one or more acidic phosphates to said food product, and
(b) determining one or more textural properties of said food product after addition of said composition to said food product;
wherein said one or more textural properties of said food product is altered when compared to said textural properties of said food product prior to addition of said composition.

2. The method of claim 1, wherein said one or more textural properties is selected from the group consisting of hardness, fracturability, cohesiveness, springiness, chewiness, gumminess and resilience.

3. The method of claim 1 wherein said altered textural property of said food product is an increase in hardness.

4. The method of claim 1 wherein said one or more acidic phosphates are selected from the group consisting of sodium acid pyrophosphate, potassium metaphosphate, sodium aluminum phosphate, monoammonium phosphate, monocalcium phosphate, ferric orthophosphate, monopotassium phosphate, hemisodium phosphate and monosodium phosphate.

5. The method of claim 4 wherein said acid phosphate is sodium acid pyrophosphate.

6. The method of claim 1 wherein said one more soy protein products are selected from the group consisting of soy flours, soy protein concentrates and isolated soy proteins.

7. The method of claim 6 wherein said soy protein product is soy protein concentrate.

8. The method of claim 1 wherein said composition additionally comprises one or more of native and modified starches, wheat gluten and flour, xanthan gum, locust bean gum, carrageenan, pectin and guar gum.

9. The method of claim 1 wherein said composition additionally comprises one or more of gelatin, egg albumin and blood plasma.

10. The method of claim 1 wherein said composition comprises about 4% sodium acid pyrophosphate, about 1.5% carrageenan, and about 94.5% soy protein concentrate, wherein the final concentration of sodium acid pyrophosphate in the food product is from 0.01% to 0.15%.

11. The method of claim 1 wherein the final concentration of acidic phosphates is from 0.01% to 10%.

12. A food product made by the method of claim 1, claim 10 or claim 11.

13. A food product comprising one or more acidic phosphates and one or more soy protein products selected from the group consisting of isolated soy protein, soy protein concentrate and soy flour, wherein one of said acidic phosphates is sodium acid pyrophosphate, and wherein the final concentration of said one or more acidic phosphates is from 0.01% to 10% of the mixture.

14. The food product of claim 13 further comprising carrageenan.

15. The food product of claim 13 wherein said sodium acid pyrophosphate final concentration is from 0.01% to 0.5%.

16. The food product of claim 15 wherein said sodium acid pyrophosphate final concentration is from 0.05% to 0.25%.

17. The food product of claim 13 which additionally comprises corn starch.

18. The food product of claim 17 which additionally comprises water, meat, salt, potato starch, sucrose, sodium nitrite, sodium tripolyphosphate, and erythorbate.

19. A composition comprising about 2% to 6% sodium acid pyrophosphate, about 0.5% to 2.5% carrageenan, and about 92% to 97% soy protein concentrate.

20. The composition of claim 19 comprising about 4% sodium acid pyrophosphate, about 1.5% carrageenan, and about 94.5% soy protein concentrate.

21. A method of using the composition of claim 19 or 20 comprising adding the composition to a food product wherein the final concentration of sodium acid pyrophosphate in the food product is from about 0.05% to 0. 15%.
